(19) United States
(12) Patent Application Publication
(10) Pub. No.: US 2025/0383947 A1
(43) Pub. Date: Dec. 18, 2025

(54) PER ROW ACTIVATION COUNTING ERROR HANDLING

(71) Applicant: Advanced Micro Devices, Inc., Santa Clara, CA (US)

(72) Inventors: Aaron John NYGREN, Boise, ID (US); Kevin M. BRANDL, Austin, TX (US); Kevin M. LEPAK, Austin, TX (US)

(21) Appl. No.: 18/745,989

(22) Filed: Jun. 17, 2024

(51) Int. Cl. G06F 11/07

(52) U.S. Cl. CPC G06F 11/076; G06F 11/0784

(57) ABSTRACT

Implementations herein describe a system including a system-on-chip and a dynamic random-access memory (DRAM) in communication with the SoC, the DRAM including at least a per row activation counting (PRAC) counter, the system configured to detect an error in the PRAC counter, transmit a signal to an alert signal logic block in the DRAM once the error in the PRAC counter has been detected, and allow the alert signal logic block to provide the signal to the SoC once the alert signal logic block receives the signal.

### BACKGROUND

Double Data Rate Synchronous Dynamic Random-Access Memory (DDR SDRAM or simply DRAM) technology is widely used for main memory in almost all applications today, ranging from high-performance computing (HPC) to power-, area-sensitive mobile applications. This is due to DDR's many advantages including high-density with a simplistic architecture, low-latency, and low-power consumption. JEDEC, the standards organization that specifies memory standards, has defined and developed four DRAM categories to guide designers to precisely meet their memory requirements, that is, standard DDR (DDR5/4/3/2), mobile DDR (LPDDR5/4/3/2), graphic DDR (GDDR3/4/5/6), and high bandwidth DRAM (HBM2/2E/3).

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a system including a system-on-chip (SoC) in communication with a dynamic random-access memory (DRAM) having a per row activation counting (PRAC) counter, according to an example.

FIG. 2 illustrates a memory array of the DRAM, according to an example.

FIG. 3 illustrates how a row hammer attack occurs in a memory array of a DRAM, according to an example.

FIG. 4 illustrates a process flow of how PRAC counter errors are immediately notified to a host of the SoC, according to an example.

FIG. 5 illustrates an alert signal logic block of the DRAM for immediately notifying the host of the SoC of a PRAC error, according to an example.

FIG. 6 illustrates a method for implementing the system of FIG. 1, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the implementations herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

DRAM can include a per row activation counting (PRAC) counter. In a PRAC implementation in the DRAM, there is a row activation count for every row address. The PRAC counter keeps track of how many times a row is activated. The activation of a row may have an effect on neighboring rows, referred to as the row hammer effect. The purpose of keeping track of the number of times every row has been activated is that the DRAM can mitigate the effects of that activation count. If the DRAM cannot keep up with the mitigation, there is an alert pin to generate an alert that there is a row hammer attack and that the host should take appropriate action. Once the host takes action, the host clears the error and moves on. A problem with that approach has arisen relating to the PRAC counter. The mitigation technique depends on the accuracy or validity of the PRAC counter. However, the PRAC counter is also prone to errors just as any other DRAM cell or other circuits in the DRAM are prone to errors. Accordingly, there is a need to develop systems and methods for identifying PRAC counter errors and immediately notifying the host of such PRAC counter errors.

Dynamic Random Access Memory (DRAM) is a type of volatile memory used in computers and other electronic devices for storing data and program code that a processor needs to access quickly. Unlike static RAM (SRAM), which uses a latching circuit to store each bit of data, DRAM uses a capacitor and transistor to store each bit. The “dynamic” aspect of DRAM refers to the fact that the capacitors holding the data need to be periodically refreshed, typically every few milliseconds, to prevent the data from decaying. This refreshing process consumes some power, but it allows DRAM to be denser and less expensive compared to SRAM.

DRAM is commonly used as the main memory (RAM) in computers, where it serves as a temporary storage for data that the CPU is actively using. However, because it is volatile memory, meaning it loses its stored information when power is removed, DRAM is used in conjunction with non-volatile storage such as hard disk drives (HDDs) or solid-state drives (SSDs) for long-term data storage.

DRAM can include error correction code (ECC) circuits. ECC is a technique used to detect and correct errors that occur during data storage or transmission in digital systems, including computer memory, storage devices, and communication channels. ECC adds extra bits to the data being stored or transmitted, allowing the detection and correction of errors that may occur due to various factors such as electrical noise, interference, or component failures.

ECC memory modules are commonly used in servers and high-end computing systems to detect and correct memory errors, ensuring data integrity and system reliability.

The master operation of the DRAM device is controlled by a clock enable (CKE), which is set to high for the DRAM to receive commands. The incoming command or address is pushed into the decoding logic of the DRAM. The first command sent to the DRAM is usually an Activate (ACT) command, which is responsible for selecting the appropriate bank and row address. The data stored in the corresponding DRAM cells are then transferred to the sense amplifiers that retain the data until a Precharge (PRE) command to the same bank is issued. Every ACT command has to have a PRE command associated with it. A READ or a WRITE can only be performed by the DRAM in its active state.

Frequently accessing a particular DRAM row causes its adjacent row's bits to flip. This problem is known as the DRAM row hammer problem. It occurs due to the electromagnetic interference between the DRAM cells, which is the result of large-scale integration in state-of-the-art semiconductor design.

Row hammer is the phenomenon in which repeatedly accessing a row in a real DRAM chip causes bit flips (i.e., data corruption) in physically nearby rows. This phenomenon leads to a widespread system security vulnerability. Recent analysis of the row hammer phenomenon reveals that the problem is getting much worse as DRAM technology scaling continues. Newer DRAM chips are fundamentally more vulnerable to row hammer at the device and circuit levels. Deeper analysis of row hammer shows that there are many dimensions to the problem as the vulnerability is sensitive to many variables, including environmental conditions (temperature & voltage), process variation, stored data patterns, as well as memory access patterns and memory control policies. As such, it has proven difficult to devise fully-secure and very efficient (i.e., low-overhead in performance, energy, area) protection mechanisms against row hammer and attempts made by DRAM manufacturers have been shown to lack security guarantees.

Per Row Activation Counting (PRAC) is a technique used to detect and correct errors in DRAM systems. In the PRAC technique, there is a row activation count for every row address. A PRAC counter keeps track of how many times a row is activated. In certain instances, the activation of the row may affect neighboring rows, which is the row hammer effect. The purpose of keeping track of the number of times every row has been activated is that the DRAM can mitigate the effects of that activation count. If the DRAM cannot keep up with the mitigation, there is an alert pin to generate an alert that there is a row hammer attack and that the host should take appropriate action. Once the host takes action, the host clears the error and moves on. A problem with that approach has arisen relating to the PRAC counter. The mitigation technique depends on the accuracy or validity of the PRAC counter. However, the PRAC counter is also prone to errors just as any other DRAM cell or other circuits in the DRAM are prone to errors.

As such, in a typical system, if a PRAC counter error is detected, the DRAM will not alert the host until some later time when the DRAM has actually determined what the exact location of the PRAC error is. If there is a problem with the PRAC counter, it can't tell the host to take action on a particular address until some time later. Moreover, depending on the DRAM implementation, it may not be practical for the DRAM to determine and communicate the row address of a PRAC counter error. There is an associated protocol in the DRAM, like an error scrubbing protocol, where the DRAM goes through all of its addresses to check (not just the counter), but all locations. Every bit cell performs a scrub to check if there any errors. The errors are recorded and transmitted to the host. This scrubbing process may be performed, e.g., once every 24 hours.

As a result, there is a relatively long period of time during which the SoC has no indication that a row may be under attack. During this time period, there is no row hammer mitigation possible for victims of the row with the PRAC counter error.

The example implementations address such issue by employing a system and method for notifying the host immediately of a PRAC counter error. A signal from within the DRAM core or wherever the error detection is occurring is sent to a logic block that also handles the alert signal that is used to indicate the PRAC backoff mechanism. Moreover, the address associated with the activated row can be stored in a similar location to the logic handling the alert signal or in mode registers where the address will later be written as part of the protocol. Thus, once the PRAC error has been detected, the address may be stored in the mode registers and an alert signal will be sent to the host according to the existing PRAC protocol. Upon receipt of the alert signal, the SoC can poll the mode registers to determine the indication of a PRAC counter error and the address of the PRACR counter error. In another example, the SoC may have a list of addresses that were assessed around the time of the alert signal and such addresses may be used as candidates for rows with a PRAC counter error if the host is aware of such an error. In the meantime, the DRAM may continue to monitor the counter bits for PRAC or disable the monitoring. The host can configure this behavior depending on how the host wants to take action on the faulty PRAC counter.

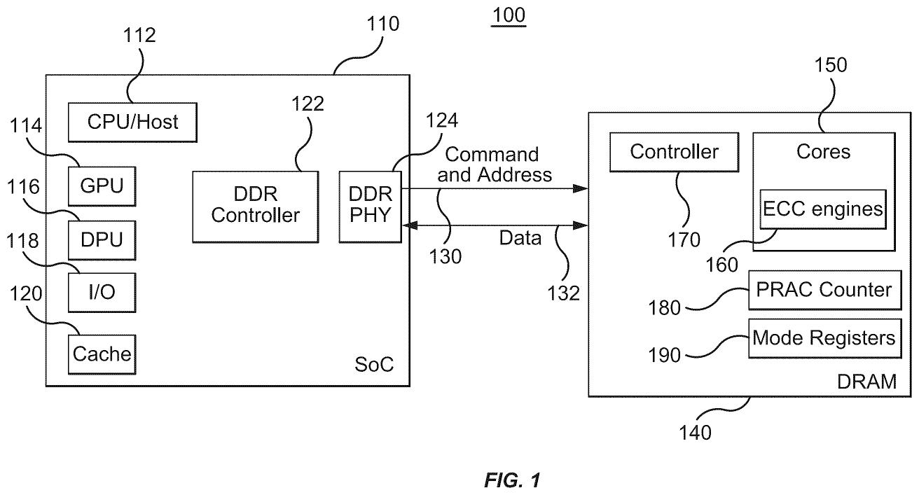

FIG. 1 illustrates a system including a system-on-chip (SoC) in communication with a dynamic random-access memory (DRAM) including error correction code (ECC) circuits, according to an example.

The system 100 includes a SoC 110 in communication with a DRAM 140.

The SoC 110 is an integrated circuit (IC) that incorporates most or all of the components of a computer or electronic system onto a single chip. This includes components such as a central processing unit (CPU) or host 112, a graphical processing unit (GPU) 114, a data processing unit (DPU) 116, memory (RAM) or cache 120, input/output (I/O) interfaces 118, storage controllers, such as a DDR controller 122, a DDR PHY 124 and various other components used for the functioning of the system.

The DDR controller 122 is responsible for managing the flow of data between the CPU or host 112 and the DDR memory modules. The DDR controller 122 controls the timing of read and write operations, manages the addressing of memory locations, and handles the synchronization of data transfers. The DDR controller 122 interprets the commands issued by the host 112 or other processing units and translates them into signals that can be understood by the DDR memory modules. As such, the DDR controller 122 interprets memory access requests from the host 112 or other processing units within the SoC 110 and coordinates the transfer of data to and from the DRAM.

The DDR PHY 124 is an interface (physical interface) between the DDR controller 122 and the DDR memory modules. The DDR PHY 124 converts digital signals from the DDR controller 122 into analog signals suitable for transmission over the memory bus (not shown) to the memory modules. The DDR PHY 124 also receives and processes the analog signals from the memory modules, converting them back into digital signals that can be understood by the DDR controller 122. The DDR PHY 124 also manages the timing and voltage levels of the signals to ensure reliable communication between the DDR controller 122 and the memory modules.

Together the DDR controller 122 and the DDR PHY 124 work in tandem to facilitate high-speed data transfer between the host 112 and the DDR memory modules in a computer system.

The DRAM 140 includes a controller 170 and DRAM cores 150. In one example, the DRAM cores 150 may include ECC engines 160. In another example, the ECC engines 160 are not embedded in the DRAM cores 150. Instead, the ECC engines 160 may be located on a datapath or in an auxiliary die. The DRAM 140 also includes a PRAC counter 180 and mode registers 190. The DRAM cores 150 are the central part of the DRAM chip where the memory cells are located. The DRAM cores 150 is where the data is stored in the form of electrical charges in capacitors. The DRAM cores 150 are organized into rows, columns, banks, and ranks. The DRAM cores 150 are accessed by the host 112 via the command and address signals 130. The DRAM cores 150 can also be referred to as the memory array.

The SoC 110 sends command and address signals 130 to the DRAM 140 to initiate read or write operations. The command and address signals 130 include instructions such as row activate, column read, column write, precharge, and refresh commands. The command and address signals 130 further include address signals to specify the location of the data to be accessed. The address signals can include row addresses and column addresses, which are used to select the appropriate memory cells within the DRAM. The SoC 110 also sends data signals 132 containing actual data to be written to or read from the DRAM modules. For example, the data signals include write data (WD) and read data (RD). Additionally, clock signals may be exchanged between the SoC 110 and the DRAM 140. The clock signals may be synchronized clock signals used to coordinate the timing of data transfers between the SoC 110 and the DRAM 140. The clock signals ensure that the data is transferred at the correct rate and timing to maintain data integrity.

Referring back to the DRAM 140, the ECC engines 160 include ECC test modes. The ECC engines 160 work as follows:

Before data is stored or transmitted, the ECC engines 160 generate additional redundant bits based on the original data. These redundant bits are calculated using mathematical algorithms, such as parity-checking schemes or more advanced codes like Hamming codes or Reed-Solomon codes. The additional bits are then appended to the original data to form an ECC codeword.

The ECC codeword, consisting of both the original data and the redundant bits, is stored in memory or transmitted over a communication channel.

When the data is read from memory or received at the destination, the ECC engines 160 recalculate the redundant bits based on the received data. If any errors have occurred during storage or transmission, the calculated redundant bits will not match the received redundant bits. This discrepancy indicates that an error has occurred.

The ECC engines 160 use the redundant bits to identify and correct errors in the received data. By analyzing the patterns of errors detected, ECC algorithms can often determine which bits are incorrect and correct them automatically. Depending on the ECC scheme used, errors can be corrected up to a certain threshold, beyond which the errors are deemed uncorrectable.

The PRAC counter 180 is designed to keep track of the number of times each row of memory in the DRAM 140 has been activated (accessed) over a period of time. The PRAC counter 180 is typically implemented as a register or a set of registers within the ECC circuitry of the ECC engines 160 associated with the DRAM 140. Each row of memory has its own PRAC counter associated with it.

The PRAC counter 180 may be implemented in a number of ways. In one example, the PRAC counter 180 may be implemented by having the bits of data stored in the DRAM array interpreted upon activation of a particular row. An interpreter may be located anywhere in the core, a datapath, or an auxiliary location, such as a base die. In another example, the PRAC counter 180 may be implemented by using registers for each row address being counted, the registers located outside the DRAM array. In yet another example, the PRAC counter 180 may be implemented by using a separate memory storage area, such as a static random access memory (SRAM).

Whenever a row of memory is activated (either for read or write operations), the corresponding PRAC counter is incremented by the ECC circuitry. This counting logic ensures that the number of activations for each row is accurately tracked. The PRAC counters are monitored by the ECC circuitry to detect abnormal patterns or thresholds. If the number of activations for a particular row exceeds a predefined threshold, it may indicate a potential error condition or degradation in memory reliability.

When an abnormal condition is detected based on the PRAC counters, the ECC circuitry can trigger error handling mechanisms, such as error correction, error reporting, or system shutdown, depending on the severity of the error and the capabilities of the ECC system.

A PRAC error may be detected using error detection logic integrated into the DRAM chip or the memory controller. The error detection logic includes parity checkers and ECC units. The parity checkers are circuits that check the parity bits associated with the PRAC counters. The ECC units can detect and correct single-bit errors and detect multi-bit errors in the counters. The ECC units generate and check the ECC bits associated with each counter value. Also, mode registers in the DRAM chip may be used to store configuration settings and status information, including error flags. The memory controller, which is part of the SoC, also aids in error detection and handling by employing a polling mechanism and error handling logic. The memory controller periodically polls the mode registers to check for any errors flagged by the DRAM and the error handling logic aids in reading the address of the faulty row from the mode registers and initiates appropriate error handling procedures. The error detection logic ensures reliable detection, reporting, and handling of errors in the PRAC counters.

As such, PRAC counters play an important role in monitoring the usage and reliability of DRAM memory in ECC-enabled systems. By tracking row activations, PRAC counters provide valuable information for error detection, correction, and system maintenance, contributing to the overall reliability and integrity of memory operations.

PRAC counter bits (not shown) refer to the number of bits used to represent the count value in the PRAC counters associated with each row of memory in the DRAM 140. The number of PRAC counter bits determines the range of counts that can be represented and monitored for each row of memory. A larger number of PRAC counter bits allow for a greater range of counts to be tracked, providing more granularity in monitoring row activations. The specific number of PRAC counter bits used in a DRAM 140 depends on various factors, including the size of the memory array and the desired level of accuracy in monitoring memory usage. As such, PRAC counter bits determine the resolution and range of counts that can be monitored for each row of memory, providing valuable information for error detection, correction, and system maintenance in DRAM systems.

However, PRAC counters themselves may experience or are prone to errors. The example implementations present a system and method for detecting the PRAC errors and immediately notifying the host of the SoC of such PRAC errors so that the host can take appropriate actions.

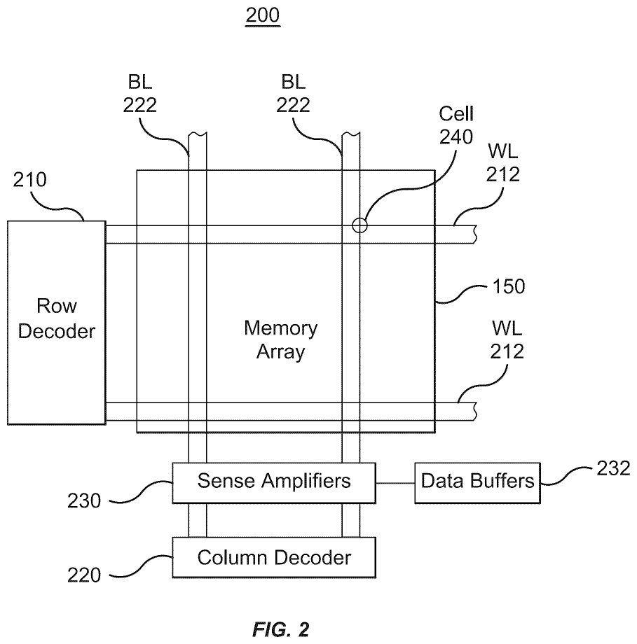

FIG. 2 illustrates a memory array of the DRAM, according to an example.

In the configuration 200, the DRAM cores 150 (or memory array) of the DRAM 140 includes a row decoder 210 and a column decoder 220. The row decoder 210 includes signal lines 212. The signal lines 212 are wordlines. A wordline is a signal line in the memory array that runs horizontally, connecting to control gates of multiple memory cells (i.e., cell 240) along a row. The column decoder 220 includes signal lines 222. The signal lines 222 are bitlines. A bitline is a signal line in the memory array that runs vertically, connecting to the source/drain terminals of multiple memory cells (i.e., cell 240) along a column. The plurality of memory cells 240 can also be referred to as DRAM cells.

Sense amplifiers 230 coupled to data buffers 232 are connected to the column decoder 220. The sense amplifiers 230 are used to detect and amplify the small signals generated by the memory cells 240 during read operations. The sense amplifiers 230 help in accurately reading the data stored in the memory array.

The DRAM 140 is composed of millions of memory cells 240, each capable of storing a single bit of data. Each memory cell 240 typically consists of a capacitor and a transistor. The capacitor holds the charge representing the data bit, and the transistor acts as a switch to control the flow of data in and out of the cell. Capacitors are the primary storage elements in DRAM cells. They hold an electrical charge to represent the binary state of the data (1 or 0). The presence or absence of charge in the capacitor corresponds to the binary state of the stored data. Transistors are used in DRAM cells to control the access to the capacitors. They act as switches, allowing the reading and writing of data to and from the memory cells. Each DRAM cell typically contains one transistor, which serves as an access mechanism for reading and writing data. DRAM cells are organized into rows and columns, forming a matrix structure. Row decoders 210 and column decoders 220 are used to select the specific row and column of cells that are accessed during read or write operations. The row decoders 210 and the column decoders 220 translate the memory addresses provided by the controller 170 into the corresponding row and column addresses within the DRAM array. These elements work together to enable the storage and retrieval of data in the DRAM 140, providing fast access speeds for efficient operation of modern computing systems.

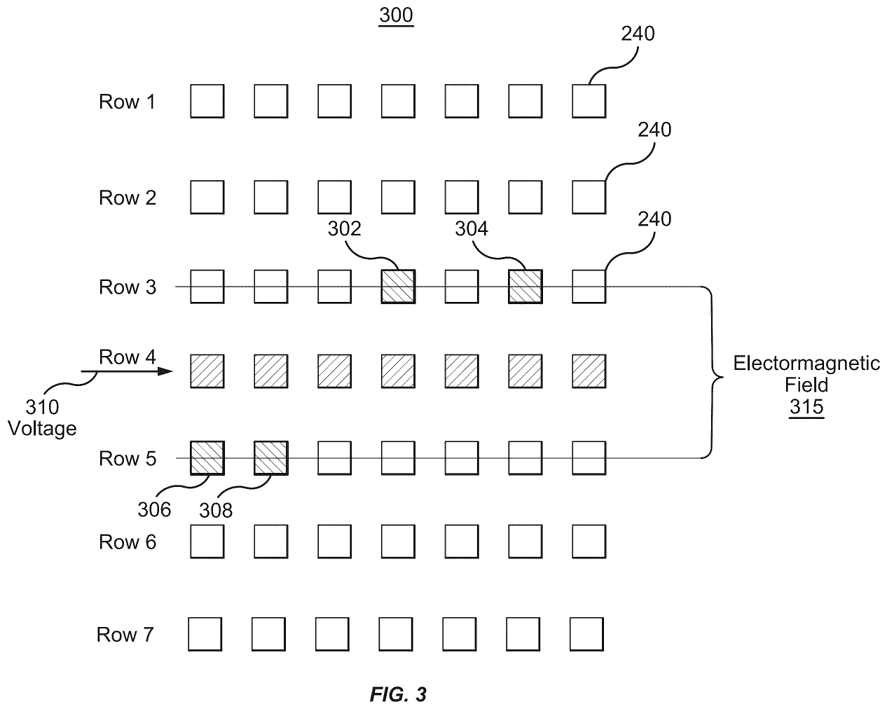

Thus, memory cells 240 are organized into rows and columns within the memory array. Each row of the memory cells 240 can be accessed or activated by a corresponding signal line 212 (i.e., word line). The PRAC counter 180 associated with each row of the memory array keeps track of the number of times that a particular row has been activated (read or written) over time. The PRAC counter 180 serves as a mechanism to detect abnormal or excessive activations of specific rows within the memory array. By monitoring row activations, the PRAC counter 180 can identify patterns indicative of potential issues, such as row hammer attacks, which may lead to data corruption in adjacent or neighboring rows, as discussed below with reference to FIG. 3. The example implementations present a system and method for detecting the PRAC errors and immediately notifying the host 112 of the SoC 110 of such PRAC errors so that the host 112 can take appropriate actions.

FIG. 3 illustrates how a row hammer attack occurs in a memory array of a DRAM, according to an example.

The schematic 300 depicts a plurality of memory cells 240 of the memory array of the DRAM 140. The memory cells 240 includes a plurality of rows and columns. In the instant example, there are 7 rows for illustrative purposes. Row 4 of the memory array is exposed to a row hammer attack. As such, row 4 of the plurality of memory cells 240 becomes repeatedly “charged” or hammered by the memory controllers “Activate” command. This can induce a loss of charge on physically adjacent cells. Cells that lose charge are known as a bit flips or coupled bits. In the instant case, DRAM cells or memory cells 302 and 304 in row 3 experience a loss of charge. Also, DRAM cells or memory cells 306 and 308 in row 5 experience a loss of charge. Since other applications could be using adjacent rows of memory cells these coupled bits could cause data corruption. The loss of electrical charge is induced through electromagnetic coupling, or leaked through conductive bridges or hot-carrier injection.

In other words, a voltage 310 may be repeatedly applied to row 4 of the plurality of memory cells 240. This causes an electromagnetic field 315 to be induced by the applied voltage 310, which in turn causes neighboring cells (e.g., memory cells 302, 304, 306, 308) to lose charge. When the memory cells 302, 304, 306, 308 lose charge, bit flips are caused. Bit flips may cause data corruption in the adjacent or neighboring row, that is, rows 3 and 5. In some examples, the electromagnetic field 315 may extend to several cells above the neighboring cells.

The example implementations present systems and methods for mitigating the row hammer attacks in FIG. 3. In particular, in a PRAC implementation in DRAM, the PRAC counter 180 keeps track of the number of times every row in the memory array has been activated so that the DRAM 140 can mitigate the effects of that activation count. If the DRAM 140 cannot keep up with the mitigation, there is an alert pin to generate an alert that there is a row hammer attack and that the host of the SOC should take appropriate action. Once the host of the SoC takes action, the host clears the error and moves on. However, such process may present an issue associated with the PRAC counter. The mitigation technique depends on the accuracy or validity of the PRAC counter. However, the PRAC counter may be prone to errors.

Therefore, errors may occur in the PRAC counter itself. For example, a problem arises if the DRAM is looking at the counter value, and once it reaches a certain threshold, the DRAM sends an alert to the host of the SoC. The host of the SoC mitigates errors within the PRAC counter. However, this may be a false indication that could be a persistent alert, which would take the DRAMs offline because there would be no way to mitigate the errors since the actual failure or errors are actually in the PRAC counter itself. In a typical scenario, the host would handle the alert caused by the PRAC counter by mitigating the issue with REF commands, a risk management framework (RFM), or other standard mitigation techniques. However, such mitigation techniques would not resolve the errors in the PRAC counter and a persistent alert loop may occur. Further, the counter error may mask the actual row hammer attack, thus lowering the count below a threshold.

The example implementations present methods below for mitigating errors cause by the PRAC counter itself.

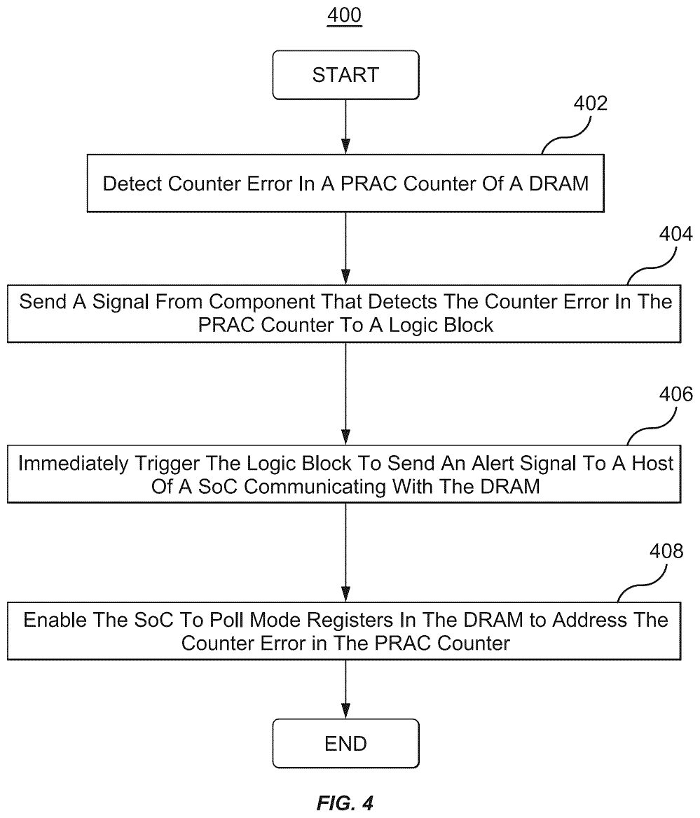

FIG. 4 illustrates a process flow of how PRAC counter errors are immediately notified to a host of the SoC, according to an example.

In typical methods, if a counter error is detected, the DRAM does not alert the host of the SoC until a later time when the DRAM has actually determined what the exact location of the error is. However, if there is a problem with the PRAC counter itself, the DRAM won't inform the host of the SoC to take action on a particular address until a much later time. The DRAM includes a protocol, such as an error scrubbing protocol, where the DRAM goes through all of its addresses to check for errors, not just the PRAC counter, but all locations. Every bit cell performs a scrub or scrubbing operation to check if there are any errors. The errors are recorded and transmitted to the host of the SoC. However, the scrubbing protocol may be performed once every 24 hours.

Therefore, in typical systems, once the counter error is determined, no immediate action takes place to remedy the detected or identified PRAC error. Once a long period of time passes by, a scrubbing protocol may be executed, and then the detected error is transmitted to the host of the SoC (once the scrub cycle is complete). However, during this time period, there may be an unknown error on the device, which could lead to, opening up that device to a row hammer attack. Currently, mitigation in such a scenario is not possible because of the host is unaware of the error in the PRAC counter. The host of the SoC is thus unaware that such error (error in the PRAC counter itself) has occurred.

Referring back to FIG. 4, the PRAC error may be mitigated by:

At block 402, a counter error is detected in a PRAC counter of a DRAM. The counter error in the PRAC counter may be detected through several mechanisms. For example, using redundancy and parity checks, regular consistency checks, self-testing mechanisms, error monitoring and logging techniques, and redundancy in counters.

At block 404, a signal is sent from the component that detects the counter error in the PRAC counter to a logic block (e.g., alert signal logic block 510). The logic block or alert signal logic block 510 refers to a specific functional block within the memory controller or DRAM module responsible for generating alert signals in response to certain predefined conditions or events. These alert signals typically indicate the occurrence of critical events or conditions that require attention from the system or the memory management subsystem.

At block 406, the logic block is immediately triggered to send an alert signal to a host of a SoC communicating with the DRAM. The alert signal logic block 510 is configured to immediately receive, in real-time, an alert signal that an error has occurred in the PRAC counter 180. The alert signal logic block 510 immediately notifies the host 112 of the SoC 110 of the PRAC counter error 182 without waiting for an error scrubbing protocol, which may take up to 24 hours to be triggered. The alert signal logic block 510 thus provides for or enables immediate notification to the host 112 once the PRAC counter error 182 has been detected or identified.

At block 408, the SoC polls the DRAM to obtain the address location of the PRAC counter error. Polling the DRAM to obtain an address location is typically part of a larger memory management and data retrieval strategy within the SoC. Polling can occur for error handling and correction reasons.

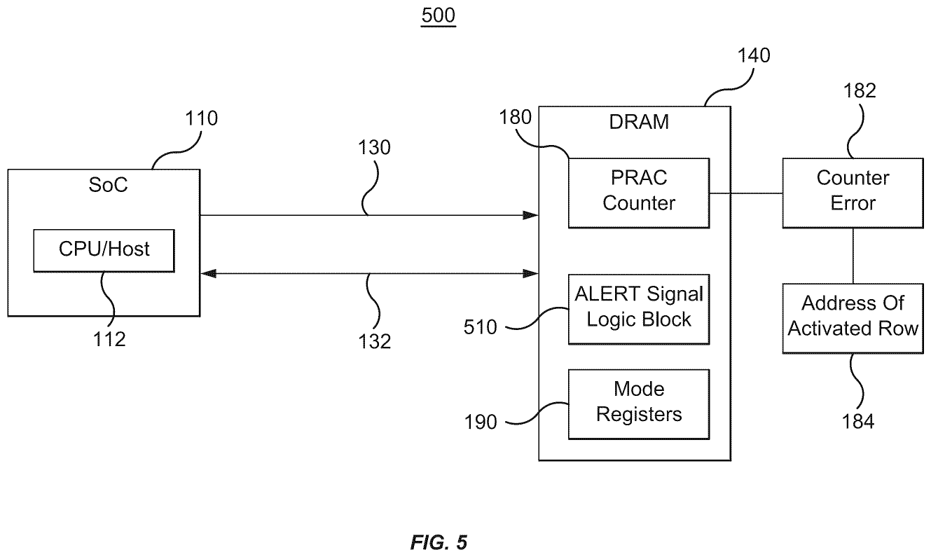

FIG. 5 illustrates an alert signal logic block of the DRAM for immediately notifying the host of the SoC of a PRAC error, according to an example.

The block diagram 500 illustrates the SoC 110 communicating with the DRAM 140. The DRAM includes the PRAC counter 180, an alert signal logic block 510, and the mode registers 190. When a PRAC counter error 182 is detected the address 184 of the activated row is stored. For example, the address 184 of the activated row can be stored within a memory of the DRAM 140 or within a memory of the alert signal logic block 510.

The logic block or alert signal logic block 510 refers to a specific functional block within the memory controller or DRAM module responsible for generating alert signals in response to certain predefined conditions or events. These alert signals typically indicate the occurrence of critical events or conditions that require attention from the system or the memory management subsystem.

The alert signal logic block 510 in the DRAM 140 can provide for event monitoring, detection and thresholds, alert generation, error handling and recovery, and integration and interface features.

The alert signal logic block 510 monitors various aspects of DRAM operation, including temperature, voltage levels, timing violations, error conditions, and other critical parameters. The alert signal logic block 510 includes circuitry to detect when monitored parameters exceed predefined thresholds or when specific error conditions occur. For example, the alert signal logic block 510 may detect excessive temperature levels, voltage fluctuations, or ECC errors. When a monitored parameter exceeds a predefined threshold or when an error condition occurs, the alert signal logic block 510 generates an alert signal. This signal serves as a notification to the controller 170, system management software, or other components of the system that action should be taken to address the detected issue. The alert signal generated by the alert signal logic block 510 triggers appropriate error handling and recovery mechanisms within the controller 170 or system software. Depending on the severity of the issue, these mechanisms may include error correction, data recovery, system shutdown, or failover to redundant components.

The signals are transmitted using, e.g., signal lines and interconnects. In one example, DRAM modules are equipped with dedicated alert lines that transmit alert signals directly from the DRAM to the memory controller or other components of the SoC. A command and address bus can also be used to transmit alert signals by encoding them into specific command sequences or address ranges. Also, a data bus may be used to transmit signals as specific data patterns to the DRAM. Additionally, many DRAM modules include an alert pin. This pin is used to signal various alert conditions, including errors detected in PRAC counters. In another example, error detection logic may be used to generate appropriate alert signals.

Overall, the alert signal logic block 510 plays an important role in ensuring the reliability, availability, and manageability of DRAM. By monitoring critical parameters and generating alert signals in response to detected issues, the alert signal logic block 510 enables timely detection and resolution of potential problems, thereby contributing to the overall stability and performance of the system.

Each mode register of the mode registers 190 is a small set of registers that control various operational parameters and configurations of the DRAM chip. These parameters can include timing settings, addressing modes, refresh rates, and other operational characteristics. The mode registers 190 allow the controller 170 or system software to configure the behavior of the DRAM chip according to the specific requirements of the system. This includes settings such as column address strobe (CAS) latency, burst length, command timing, and power-down modes. The mode registers 190 in the DRAM 140 provide a mechanism for configuring and fine-tuning the operational parameters of the memory chip to optimize performance, power consumption, and reliability within the system.

The mode registers 190 are specialized registers within the DRAM modules that store configuration settings and control various operational modes of the memory. The mode registers 190 are beneficial for the initialization, configuration, and management of the DRAM. If an error is detected in the PRAC counter, the mode registers 190 can be updated with error status information using error detection, error logging, and error handling.

The alert signal logic block 510 is configured to immediately receive, in real-time, an alert signal that an error has occurred in the PRAC counter 180. The alert signal logic block 510 immediately notifies the host 112 of the SoC 110 of the PRAC counter error 182 without waiting for an error scrubbing protocol, which may take up to 24 hours to be triggered. The alert signal logic block 510 thus provides for or enables immediate notification to the host 112 once the PRAC counter error 182 has been detected or identified.

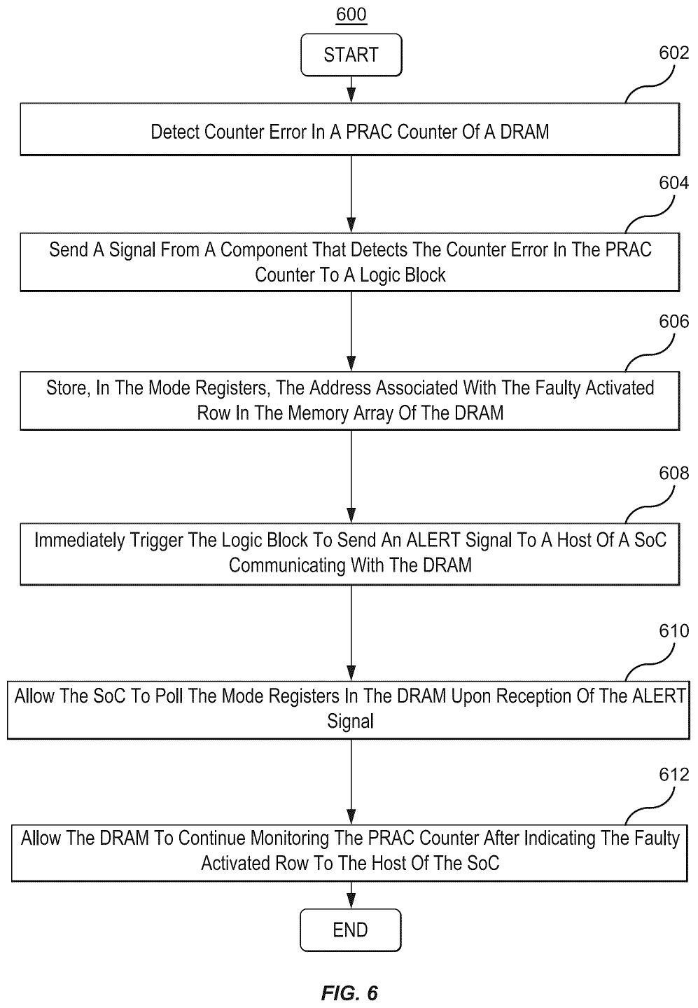

FIG. 6 illustrates a method for implementing the system of FIG. 1, according to an example.

At block 602, a counter error is detected in a PRAC counter of a DRAM. The counter error in the PRAC counter may be detected through several mechanisms. For example, using redundancy and parity checks, regular consistency checks, self-testing mechanisms, error monitoring and logging techniques, and redundancy in counters.

At block 604, a signal is sent from the component that detects the counter error in the PRAC counter to a logic block (i.e., the alert signal logic block 510). The logic block or alert signal logic block 510 refers to a specific functional block within the memory controller or DRAM module responsible for generating alert signals in response to certain predefined conditions or events. These alert signals typically indicate the occurrence of critical events or conditions that require attention from the system or the memory management subsystem.

At block 606, the address associated with the faulty activated row in the memory array of the DRAM is stored in the mode registers. Storing the address of a faulty row helps in identifying which specific row is experiencing issues, which is beneficial for debugging and diagnosing the root cause of errors in the DRAM.

At block 608, the logic block is immediately triggered to send an alert signal to a host of a SoC communicating with the DRAM. The alert signal logic block 510 is configured to immediately receive, in real-time, an alert signal that an error has occurred in the PRAC counter 180. The alert signal logic block 510 immediately notifies the host 112 of the SoC 110 of the PRAC counter error 182 without waiting for an error scrubbing protocol, which may take up to 24 hours to be triggered. The alert signal logic block 510 thus provides for or enables immediate notification to the host 112 once the PRAC counter error 182 has been detected or identified.

At block 610, the SoC polls the mode registers in the DRAM upon reception of the alert signal. Polling the DRAM to obtain an address location is typically part of a larger memory management and data retrieval strategy within the SoC. Polling can occur for error handling and correction reasons.

At block 612, the DRAM continues to monitor the PRAC counter after indicating the faulty activated row to the host of the SoC. Thus, despite the detected error, the PRAC counter is continuously incremented to help in tracking whether other issues persist. Additional thresholds can set for the PRAC counter.

Therefore, the alert signal logic block 510 is configured to receive, in real-time, an alert signal that an error has occurred in the PRAC counter 180. The alert signal logic block 510 immediately notifies the host 112 of the SoC 110 of the PRAC counter error 182 without waiting for an error scrubbing protocol, which may take up to 24 hours to be triggered.

In conclusion, DRAM is the dominant technology used for main memory in almost all computing systems due to its low latency and low cost per bit. Modern DRAM chips suffer from a vulnerability commonly known as the row hammer effect. The row hammer effect is caused by repeatedly accessing (i.e., hammering) one or more (aggressor) memory rows. Hammering a row creates electromagnetic interference between the aggressor row and its physically-neighboring (victim) rows. Due to this interference, cells in victim rows lose the ability to correctly retain their data, which leads to data corruption (i.e., bit flips). These bit flips are repeatable: if hammering an aggressor row causes a particular cell to experience a bit flip, doing so again will lead to the same bit flip with high probability. Unfortunately, DRAM becomes increasingly more susceptible to row hammer bit flips as its storage density increases (i.e., DRAM cell size and cell-to-cell spacing reduce). Malicious applications can be written to induce row hammer bit flips in a targeted manner, so as to specifically degrade system security, privacy, safety and availability. For example, by carefully selecting rows to hammer, an attacker can induce bit flips in sensitive data stored in DRAM.

The example implementations mitigate the occurrence of row hammer attacks in DRAM by immediately notifying the host of the SoC that a PRAC counter error has occurred. Once the PRAC counter error is detected, a signal is immediately sent to an alert signal logic block that handles alert signals used to indicate the PRAC backoff mechanism. The address associated with the activated row can be stored in a similar location to the logic handling the alert signal or in mode registers. Once the PRAC error has been detected, the address will be stored and an alert signal will be immediately sent to the host of the SoC according to the existing PRAC protocol. Upon receipt of the alert signal, the SoC can poll the mode registers to determine the indication of a PRAC counter error and the address of the PRAC counter error. In the meantime, the DRAM may continue to monitor the counter bits for PRAC or disable the monitoring. The host can configure this behavior depending on how the host wants to take action on the faulty PRAC counter.

The systems and methods described herein employ an immediate alert mechanism to indicate to the host of the SoC that a PRAC counter error has occurred. The systems and methods allow for immediate mitigation of the faulty row without exposing the device to row hammer attacks. Such systems and methods may be beneficial in automotive ECC circuits. Such methods and systems may be beneficial in other practical applications.

In the preceding, reference is made to implementations presented in this disclosure. However, the scope of the present disclosure is not limited to specific described implementations. Instead, any combination of the described features and elements, whether related to different implementations or not, is contemplated to implement and practice contemplated implementations. Furthermore, although implementations disclosed herein may achieve advantages over other possible solutions or over the prior art, whether or not a particular advantage is achieved by a given implementation is not limiting of the scope of the present disclosure. Thus, the preceding aspects, features, implementations and advantages are merely illustrative and are not considered elements or limitations of the appended claims except where explicitly recited in a claim(s).

As will be appreciated by one skilled in the art, the implementations disclosed herein may be embodied as a system, method or computer program product. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to implementations presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
a system-on-chip (SoC); and
a dynamic random-access memory (DRAM) in communication with the SoC, the DRAM including at least a per row activation counting (PRAC) counter, the system configured to:
detect an error in the PRAC counter;
transmit a signal to an alert signal logic block in the DRAM once the error in the PRAC counter has been detected; and
allow the alert signal logic block to provide the signal to the SoC once the alert signal logic block receives the signal.

2. The system of claim 1, wherein an address associated with an activated row of a memory array of the DRAM is stored in the alert signal logic block.

3. The system of claim 1, wherein an address associated with an activated row of a memory array of the DRAM is stored in mode registers.

4. The system of claim 3, wherein, once the SoC receives the signal from the alert signal logic block, the SoC polls the mode registers to evaluate the error detected in the PRAC counter.

5. The system of claim 1, wherein, as the alert signal logic block sends the signal to the SoC, the DRAM continues to monitor the PRAC counter for row hammer mitigation.

6. The system of claim 1, wherein, as the alert signal logic block sends the signal to the SoC, monitoring of the PRAC counter is disabled.

7. The system of claim 1, wherein the alert signal logic block sends the signal to the SoC without waiting for an error scrubbing protocol to be initiated.

8. A dynamic random-access memory (DRAM) comprising:
a DRAM core; and
a per row activation counting (PRAC) counter, the DRAM communicating with a system-on-chip (SoC) to:
detect an error in the PRAC counter;
transmit a signal to an alert signal logic block in the DRAM once the error in the PRAC counter has been detected; and
allow the alert signal logic block to provide the signal to the SoC once the alert signal logic block receives the signal.

9. The DRAM of claim 8, wherein an address associated with an activated row of a memory array of the DRAM is stored in the alert signal logic block.

10. The DRAM of claim 8, wherein an address associated with an activated row of a memory array of the DRAM is stored in mode registers.

11. The DRAM of claim 10, wherein, once the SoC receives the signal from the alert signal logic block, the SoC polls the mode registers to evaluate the error detected in the PRAC counter.

12. The DRAM of claim 8, wherein, as the alert signal logic block sends the signal to the SoC, the DRAM continues to monitor the PRAC counter for row hammer mitigation.

13. The DRAM of claim 8, wherein, as the alert signal logic block sends the signal to the SoC, monitoring of the PRAC counter is disabled.

14. The DRAM of claim 8, wherein the alert signal logic block sends the signal to the SoC without waiting for an error scrubbing protocol to be initiated.

15. A method comprising:
detecting an error in a per row activation counting (PRAC) counter of a dynamic random-access memory (DRAM);
transmitting a signal to an alert signal logic block in the DRAM once the error in the PRAC counter has been detected; and
transmitting, by the alert signal logic block, the signal to a system-on-chip (SoC) in communication with the DRAM once the alert signal logic block receives the signal.

16. The method of claim 15, wherein an address associated with an activated row of a memory array of the DRAM is stored in the alert signal logic block.

17. The method of claim 15, wherein an address associated with an activated row of a memory array of the DRAM is stored in mode registers.

18. The method of claim 17, wherein, once the SoC receives the signal from the alert signal logic block, the SoC polls the mode registers to evaluate the error detected in the PRAC counter.

19. The method of claim 15, wherein, as the alert signal logic block sends the signal to the SoC, the DRAM continues to monitor the PRAC counter for row hammer mitigation.

20. The method of claim 15, wherein, as the alert signal logic block sends the signal to the SoC, monitoring of the PRAC counter is disabled.
